(19) United States
(12) Patent Application Publication
(10) Pub. No.: US 2012/0135217 A1
(43) Pub. Date: May 31, 2012

(54) Hybrid Polymers from Cyanates and Silazanes, Process for Their Production and Use

(75) Inventors: Monika Bauer, Konigs Wusterhausen (DE); Daniel Decker, Liederbach (DE); Frank Richter, Frankfurt am Main (DE); Maciej Gwiazda, Berlin (DE)

(73) Assignees: Clariant International, Ltd., Muttenz (CH); Fraunhofer-Gesellschaft zur Foerderung der angewandten Forschung e.V., Muenchen (DE)

(21) Appl. No.: 13/257,085

(22) PCT Filed: Mar. 16, 2010
(86) PCT No.: PCT/EP10/53405

§ 371 Date: Feb. 16, 2012

(30) Foreign Application Priority Data
Mar. 16, 2009 (DE) 102009013410.7

(51) Int. Cl. C08L 83/16; B32B 17/02; C08G 77/62

(52) U.S. Cl. 428/221; 528/28; 524/588; 528/27; 525/474

(57) ABSTRACT

This invention refers to hybrid pre-polymers and polymers, produced through conversion from difunctional, oligofunctional and/or polyfunctional cyanates and/or from their pre-polymers with monomeric, oligomeric and/or polymeric silazanes. The polymers are duromers with high glass transition temperature and fracture toughness, compared to duromers from the respective cyanate source material. In their pre-polymerized state, they can be dissolved in solvents and are therefore suitable as impregnating resins for prepregs. In addition, they can be processed to become moldings. Their burning properties are described as particularly outstanding.

This invention refers to hybrid pre-polymers and polymers, produced through conversion from difunctional, oligofunctional and/or polyfunctional cyanates and/or from their pre-polymers with monomeric, oligomeric and/or polymeric silazanes. The polymers are duromers with high glass transition temperature and very high fracture toughness compared to duromers from the respective cyanate source material. In their pre-polymerized state, they can be dissolved in solvents and are therefore suitable as impregnating resins for prepregs. In addition, they can be processed to become moldings. Their burning properties are described as particularly outstanding.

Lightweight, plastic materials that suppress fire or have a fire-suppressing effect and should also meet the requirements for high mechanical stability are increasingly being needed for the manufacturing of moldings—for example, from cast resins, coated flat surfaces, adhesives, adhesion promoters and others. One of the frequent requirements made to the fire behavior is a low heat release rate, a low flue gas density, a low toxicity of the fire gases formed as well as a high fire residue.

Liquid or viscous resins are often used for these purposes because they can be subsequently cross-linked with the help of heat and/or pressure. Owing to the fire requirements mentioned above, phenolic resins are especially used for such purposes, but these phenolic resins cannot supply the required mechanical properties. For applications where impact loads occur, for instance, their high brittleness in particular can be a problem.

Furthermore, there are special requirements for the manufacturing of resins for various applications. One example is the stickiness behavior (the so-called tack or the power of reactivation of tack) that must be ensured, if applicable, by modifying (formulating) the resin. Such a stickiness behavior is needed for adhesives, prepreg resins, binders for laminates or adhesion promoters, for example.

To formulate resins from which flame-protected and strengthened flat surfaces (prepregs) can be made, the specialized trade gladly falls back on addition resins because, among other reasons, no low-molecular by-products that could lead to bubble formation are produced during their polymerization. Addition resins with good mechanical properties are epoxy resins and cyanate resins. The currently commercially available epoxy resins are not sufficiently flame resistant for certain purposes because their fire load is too high (specifically, the flue gas density) and are therefore not permitted. Although highly flame-resistant halogenated epoxy resins are known from electronics, the use of halogens produces highly toxic and highly corrosive gases in case of fire, and for this reason their use is generally not considered.

Cyanate resins, on the other hand, possess an intrinsic flame resistance owing to their high proportion of nitrogen and network structure. They combine low heat release rate with low flue gas density and a low proportion of toxic gases when a fire occurs. As a rule, they have high glass transition temperatures and low fracture toughness values.

The word “silazanes” generally denotes compounds that contain the R¹R²R³Si—N(R⁴)SiR⁵R⁶R⁷ group, and disilazane (H₃Si—NH—SiH₃) is a very simple representative of this group. Cyclic and linear silazanes comprise or consist of the —Si(R¹R²)—N(R³)— structural units. Starting from the basic structures, a multitude of silazanes has been developed, whose silicon substituent can be, apart from hydrogen, alkyl, alkenyl or aryl, and their nitrogen substituent can be, apart from hydrogen, alkyl or aryl. Oligomeric and polymeric structures exist, also with the incorporation of additional groups (e.g. urea groups and various rings and multiple rings).

Addition polymers of polysilazanes with isocyanates, isothiocyanates, ketens, thioketens, carbodiimides and carbon disulfides have been described in U.S. Pat. No. 4,929,704, U.S. Pat. No. 5,001,090 and U.S. Pat. No. 5,021,533. The products were then examined to see whether they would be suitable as starting materials for ceramics containing silicon nitride. Applications U.S. Pat. No. 5,843,526 and U.S. Pat. No. 6,165,551 describe compositions prepared by converting poly-urea silazanes with boron compounds. U.S. Pat. No. 6,534,184 B2 describes polysilazane/polysiloxane block copolymers.

More recently, the conversion of specific polysilazanes with isocyanates has been examined more closely. With aromatic isocyanates, the reaction is already vigorous—fast and strongly exothermic—at room temperature, whereas it is more moderate with aliphatic isocyanates—under certain conditions the reaction even needs to be supplied with mild heat so it can be fully completed. In this reaction, the isocyanate group is inserted between the Si—N group of the silazane, so that one finds urea groups in the polymer. The conversion of polysilazanes with monoisocyanates, therefore, does not change the product's state of polymerization and does not add any additional reactive groups to the material either.

The inventors of this invention have taken the task upon themselves to make polymers available with even better fire behavior, a high glass transition temperature and relatively very high fracture toughness compared to polycyanates. On the one hand, the polymers should allow the production of malleable/meltable pre-polymers available as substances or in solution under relatively mild conditions and suitable, for example, for the manufacture of prepregs or moldings from which duromers can be made by post-curing (under pressure and/or higher temperature). On the other hand, it should also be possible to produce the polymers in one step by fully hardening cast resins obtained from mixing the starting components, for example.

These requirements correspond to the profile of the so-called RTM resins, which can be converted to a state that is still liquid under moderate temperatures and are therefore suitable for infusion processes, i.e. for processes in which a pre-form (that can contain a stabilizing tissue) is impregnated with the relatively low-viscous resin. Nowadays, epoxy and bismaleimide resins are used especially as RTM resins, but none of them is sufficiently fireproof. It would also be desirable if the cross-linking temperatures (currently approx. 200° C.) could be lowered even further.

The inventors were surprised to find out that this task could be solved by the supply of hybrid pre-polymers and duromers from cyanates and silazanes.

As mentioned above, isocyanates are inserted into the Si—N bond of silazanes under the formation of urea groups. Responsible for this is the fact that the nitrogen in the isocyanate group carries a negative and the carbon a positive partial charge, so that the insertion takes place with the formation of a nitrogen bond to the silicon and a formation of a carbon bond to the nitrogen, in which case the N=C bond in the isocyanate group is converted to a single bond. For converting silazanes with cyanates, the specialist would expect a cleavage into two molecules under comparable conditions because when there is an insertion of a cyanate group with negative partial charge on the oxygen and a positive partial charge on the carbon into the Si—N bond of the silazane, the O—C single bond of the cyanate would have to be cleaved.

Surprisingly, polymerizable resins can nonetheless be obtained by combining silazanes with cyanates. With the help of some model experiments with arylcyanates, the inventors found out that in a first step, nitrile groups were transferred to the nitrogen of the silazane groups. The aryl alcohol formed in this way cleaves a Si—N bond of another silazane or of the formed nitrile-substituted silazane in a second step and a cyanamide was formed, among others. Finally, triazine structures are formed by way of additional by-products containing nitrile terminal groups, and these triazine structures are substituted with —O—R— and/or —NH—R groups depending on their silazane proportion. Owing to the di- or polyfunctionality of the used cyanates, through these groups a network is therefore formed in the hybrid pre-polymers according to the invention. The polymerizable resins form especially when excess cyanate relative to silazane is used, as described in more detail below.

The hybrid pre-polymers according to the invention can be cured to duromers with improved properties. Compared to pure cyanates, improved fracture toughness could especially be determined. The curing temperatures during duromer production are also lower compared to pure cyanates and other cyanate polymers such as epoxy cyanates, for example; the reaction is also less exothermic, making the reaction easier to control. Finally, a clearly enhanced fire resistance could be documented—it was even better than that of isocyanate-silazane copolymers—even when the duromers contained only relatively little silazane, which owing to its high nitrogen content, is intrinsically more fire resistant.

The hybrid polymers are obtained through the conversion of one or several difunctional, oligofunctional or polyfunctional cyanates or mixtures thereof and/or from their pre-polymers with one or several monomeric, oligomeric or polymeric silazanes or mixtures thereof and, if need be, additionally from one or several components. For this, mixtures of the starting components can be used or the conversion can also be done with a solvent for dissolving both components. In a first step, soluble and/or re-meltable polymers are formed that can be cured by the action of higher temperatures, which generates duromers. Alternately, the starting materials are mixed, brought to their desired form, and fully cured in one step.

According to the invention, “oligofunctional cyanates” are understood to be cyanates with 3 to 10 cyanate groups. Consequently, polyfunctional cyanates are those with at least 11 cyanate groups.

According to the invention, “oligomeric silazanes” are understood to be silazanes with 2 to 10 silicon atoms. Consequently, polymeric silazanes are those with at least 11 silicon atoms.

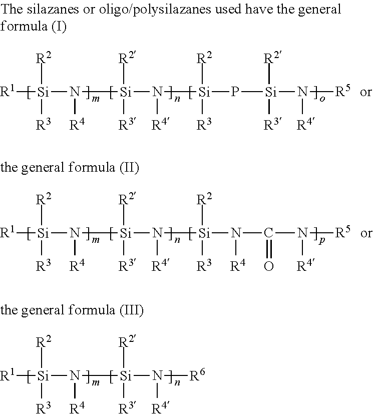

wherein
(a) R² and R³ are equal or different and mean hydrogen or a straight-chain, branched or cyclic, substituted or—preferably—non-substituted alkyl, alkenyl, aryl, arylalkyl, alkylaryl, alkenylaryl or arylalkenyl, in which case every one of the substituents R² and R³ is larger than 1 in the case of m and/or o and can have a different meaning in different units, but preferably the same meaning,
R²′ and R³′ are equal or different and mean a straight-chain, branched or cyclic, substituted or—preferably—non-substituted alkyl, alkenyl, aryl, arylalkyl, alkylaryl, alkenylaryl or arylalkenyl, in which case every one of the substituents R²′ and R³′ is larger than 1 in the case of m and/or o and can have a different meaning in different units, but preferably the same meaning,
or
(b) R² and R²′ have the meaning indicated above and—if at least a group R³ and at least a residue R³′ are present—all or in each case a portion of the R³ and R³′ residues together can represent a non-substituted or substituted, straight-chain or branched alkylene group with preferably 2 bridging carbon atoms, in which case, if applicable, the remaining portion of the R³ and R³′ residues has the meaning given under (a),
   and wherein
   R⁴ and R⁴′ mean alkyl with preferably 1 to 4 carbon atoms, phenyl or—preferably— hydrogen, in which case several R⁴ and/or R⁴′ residues can be the same or different in a silazane molecule,
   R¹ and R⁵ are the same or different and can have the same meaning as R² or R³, in which case R⁵ can also mean Si(R¹)(R²′)(R³′), or R¹ and R⁵ together represent a single bond,
   R⁶ means Si(R²)(R²′)—X—R⁷—Si(R²)q(OR²′)_{3-q}, wherein X means either O or NR⁴, R⁷ represents a single bond or a substituted or—preferably—a non-substituted, straight-chain, branched or cyclic alkylene group and q can be 0, 1, 2 or 3, P is an alkylene group with 1 to 12 carbon atoms, preferably ethylene, m and p mean independently from one another 1, 2, 3, 4, 5, 6, 7, 8, 9, 10 or an integer between 11 and 25000, preferably between 11 and 200, and n and o mean independently from one another 0, 1, 2, 3, 4, 5, 6, 7, 8, 9, 10 or an integer between 11 and 25000, preferably between 11 and 200, in which case the units placed in square brackets are preferably randomized, in other cases they can be instead distributed block-wise and, if need be, alternately in a uniform way in the respective molecule.

The expression “units” within the context of the definition of the silazanes with the formulas (I) to (III) refers to the molecular parts placed in each case in a square bracket and furnished with an index (m, n . . . ) indicating the quantity of these units in the molecule.

In a first (preferred) embodiment, the substituents (R² and R³ or R²′ and R³′) bound in each case to a silicon atom have been selected as follows in the formulas (I) to (III): An alkyl residue in combination with a hydrogen atom, another alkyl residue, an alkenyl residue, preferably a vinyl residue, or a phenyl residue.

In a second preferred embodiment independent from the other, the alkyl or alkenyl residues have 1 to 6 carbon atoms in the formulas (I) to (III). Methyl, ethyl and vinyl residues are especially preferred. It is preferred for the aryl, arylalkyl, alkylaryl, alkenylaryl or arylalkenyl residues to have 5 to 12 carbon atoms. Phenyl and styryl residues are especially preferred. This embodiment is especially preferred when combined with the first one.

In a further, preferred embodiment of the formulas (I) to (III) independent from the above, R⁴ and/or R⁴′ are selected among hydrogen and methyl.

In a fourth, preferred embodiment from it, R², R³, R²′ and R³′ are preferably selected among alkyl, especially with 1 to 8 carbon atoms.

In a fifth embodiment independent of the former, the substituents carry R², R³, R²′ and R³′ fluorine atoms. This embodiment is especially preferred when combined with the fourth one.

In another independent preferred embodiment of the formula (I), the index o equals 0.

In another independent preferred embodiment of the formulas (I) or (II), the index in each case equals 0.

In another independent preferred embodiment, R¹ and R⁵ together make up a single bond. This embodiment is especially preferred for compounds having the formula (I), wherein the index o is zero and, if applicable, the index m is also zero.

In a further independent preferred embodiment, o equals 0 and m and n are larger than 1 and lie preferably between 2 and 25000, especially between 2 and 200. In this case, m and n can be equal or different. Additionally or alternately, the m and n units can be randomized or be equally distributed. In this, they can be arranged in blocks or not in blocks.

In another independent preferred embodiment from it, n and o mean zero in the formula (I) and R⁵ means Si(R¹)(R²′)(R³′). Examples of this embodiment (m=1 here) are:

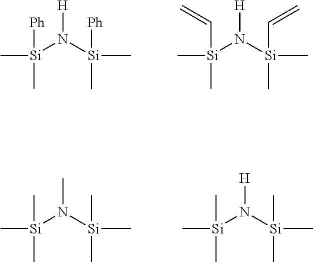

In these examples, the lines indicating single bonds can especially stand for alkyl, and very preferably for methyl, but also for hydride or partially for alkyl and partially for hydride.

In another preferred independent embodiment, m in formula (I) means 1, 2, 3, 4, 5 or an integer between 6 and 50, while n and o are zero, or it is a mixture of various of these silazanes. In this case, the substituents R¹ and R⁵ can be equal or different and mean the same as R² or R³, whereby R⁵ can additionally mean Si(R¹)(R²′)(R³′). This silazane or these silazanes can, if applicable, also be present especially mixed with silazanes, in which R¹ and R⁵ together represent a single bond.

Examples of this are the following oligomers/polymers:

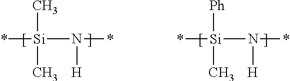

In another independent preferred embodiment, o is zero in the formula (I), while m and n are equal or different and mean between 2 and 200-25000. Here, the substituents R¹ and R⁵ are equal or different and have the same meaning as R² or R³, in which case R⁵ can also mean Si(R¹)(R²′)(R³′). This silazane or these silazanes can, if applicable, also be present especially mixed with silazanes, in which R¹ and R⁵ together represent a single bond.

Examples are the following oligomers/polymers,

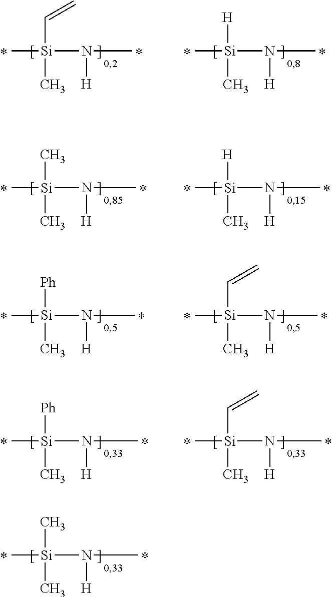

here, the molecular units placed in square brackets are randomized or, if applicable, arranged in blocks and, in other instances, uniformly arranged in the given ratio to one another and the molecules contain terminal hydrogen atoms or alkyl or aryl groups.

In another independent preferred embodiment, the indices n and o are zero, and the index m means 3, and R¹ and R⁵ together represent a single bond. This embodiment is generally represented with the formula (Ia):

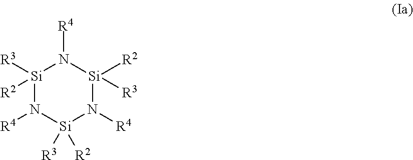

wherein R², R³ and R⁴ have the meaning indicated by formula (I).

In another independent preferred embodiment of the formula (I), n and o equal 0, m means 2, 3, 4, 5, 6, 7, 8, 9, 10 or a higher number, and R¹ and R⁵ represent together a single bond. These compounds can, in turn, be exemplarily represented by formulas such as

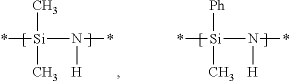

in which case the units inside square brackets are available n times.

In another independent preferred embodiment of the formulas (I) and (II), m and n mean in each case 2, 3, 4, 5, 6, 7, 8, 9, 10 or a higher number, and R¹ and R⁵ represent together a single bond. These compounds can (here for o or p equals 0), in turn, be exemplarily represented by formulas such as

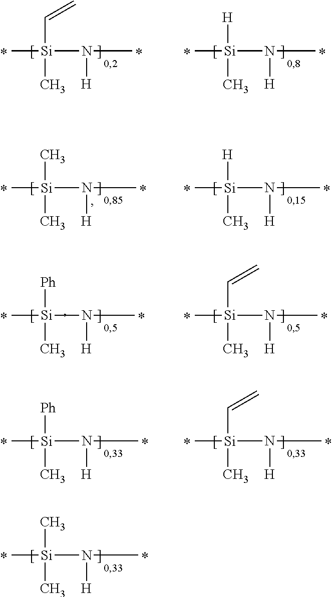

in which case, once again, the units placed inside the square brackets in the molecules are distributed in a random way or in blocks, sometimes also uniformly, m or n times, or in the case of the last formula shown, together (m+n) times in the indicated ratio to one another, but the molecules are in closed chain form. This variant can be provided especially as a mixture with the corresponding open-chain silazanes and used for this invention.

In another independent preferred embodiment of the formulas (I) or (II), the index n equals 0 and the indices m and o or p are larger than 1 and lie preferably between 2 and 200-25000. An example for formula (I) is the specific silazane shown below:

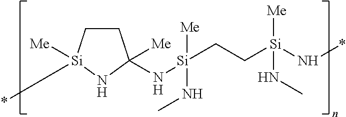

In this embodiment, it has been especially preferred for the m and o units to be uniformly distributed and available in equal quantity, i.e. that a unit o should always follow a unit m. In the compound with the formula (II), the m and p units, on the other hand, can be arranged preferably randomly or in blocks.

In a further, independent preferred embodiment of formula (II), the substituent R⁴ means a phenyl group available p times in the unit.

In another preferred embodiment of the formula (I), o equals 0, R¹ and R⁵ represent a single bond, m and n mean in each case 2 or more than 2 and all R³ residues form an alkylene group with the R³′ residues. This silazane is an example of the embodiment:

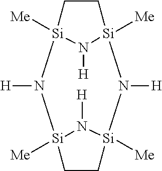

As far as the embodiments called preferred above do not exclude one other, it is very preferred to combine two or more from each.

In another independent preferred embodiment, a mixture of at least two silazanes or a mixture of at least one silazane with at least one silane is prepared for achieving an additional cross-linking of the silazane component. In doing this, the components should obey one of the following conditions:
(a) A (first) silazane contains at least one N—H group, the second silazane or the silane at least one Si—H group. The components can be cross-linked through dehydrocoupling (under splitting off of H₂ and formation of a Si—N(Si)—Si group).
(b) A (first) silazane contains at least one Si-vinyl group, the second silazane or the silane contains at least one Si—H group. The hydrosilazane or hydrosilane attacks the C=C double bond and forms a —Si—C—C—Si— group (hydrosilylation).
(c) A first silazane with a NH group is subjected to a trans-amination with a second silazan, resulting in a cross-linked product with the Si—N(Si)—Si grouping and a silylamine.

This embodiment can be used on all previous silazanes as long as they contain the mentioned groups. The cross-linking reactions mentioned above should preferably take place before the cyanate component is added.

If according to the invention one or several vinyl silazanes are used, then it is possible to subject them—before conversion with the cyanate(s)—to an addition polymerization. Alternately, the polymerization of the double bonds can also be done after the hybrid polymer has been formed.

Silazanes having the formula (I) with o equals 0 are available commercially and produced according to standard processes, especially by the ammonolysis of monohalogen silanes, examples are described in U.S. Pat. No. 4,395,460 and in the literature cited therein. The conversion of a monohalogen silane with three organic residues produces, for example, silazanes having the formula (I), wherein the indices n and o equal zero, and the index m means 1 and R⁵ has the meaning of Si(R¹)(R²′)(R³′). The organic residues are not split off during the reaction.

It is likewise possible, analogously to U.S. Pat. No. 6,329,487 B1 of Kion Corporation, to subject mono-, di-, or trisilanes to ammonolysis in liquid ammonia in a pressure chamber in order to obtain in this way silazanes having the general formula (I).

If in this case halogen silanes are converted with at least one Si—H bond alone and/or in combination with di- or tri-halogen silanes in an excess of liquid, anhydrous ammonia and left a longer period of time in this medium, polymerization products form due to the ammonium halogenide salt or the respective acid that forms in the more acidic environment over time through the reaction of the Si—H bonds. In these polymerization products, the m, n and o indices have a higher value and/or are in another ratio as before, possibly catalyzed through the presence of dissolved and ionized ammonium halogenide.

Similarly, U.S. Pat. No. 6,329,487 B1 describes that the corresponding polymerization products can be obtained through the action of sodium dissolved in ammonia.

U.S. Pat. No. 4,621,383 and WO 87/05298 furthermore describe the possibility of synthesizing polysilazanes by way of reactions catalyzed by transitional metals.

By suitably selecting the organic substituents on the silicon atom of the silane or a mixture of the corresponding starting silanes, many formula (I) silanes wherein the o index is zero can be produced with this process. In this case, a mixture of linear and chain-formed polymers is created.

Regarding the reaction mechanism, see Michael Schulz's dissertation done at the Materials Research Institute of the Karlsruhe Research Center: “Mikrostrukturierung präkeramischer Polymere mit Hilfe der UV—und Röntgentiefenlithographie” [Micro-structuring of Pre-ceramic Polymers with the Help of UV and Deep X-ray Lithography], November 2003, FZKA 6901. The dissertation also describes the production of silazanes with the formula (I) wherein the index o is zero and the silicon atoms that carry different substituents in the blocks that have the indices m and n.

The research paper also makes reference to the production of urea-silazanes: If one adds monofunctional isocyanates to silazanes, an insertion reaction of the NCO group takes place in the N—H bonds, thereby forming a urea group [see the silazanes of formula (II) described previously]. Incidentally—and regarding the production of urea-silazanes and poly (urea-silazanes), we refer to U.S. Pat. No. 6,165,551, U.S. Pat. No. 4,929,704 and U.S. Pat. No. 3,239,489 verwiesen.

The production of compounds having the formula (III) (alkoxy-substituted silazanes) is known from U.S. Pat. No. 6,652,978 B2. For producing these compounds, monomeric or oligomeric/polymeric silazanes having the formula (I), wherein o is zero, can be converted with alkoxysilanes containing amino or hydroxyl groups: For example, 3-aminopropyltriethoxysilane.

G. Motz presents in his dissertation a production process for compounds having the formula (I) with o unequal to zero (G. Motz, dissertation, University of Stuttgart, 1995), using the specific example of ammonolysis of the 1,2-bis(dichloromethyl-silyl)ethane. The production of a special representative of these compounds, ABSE, is caused by hydrosilylation and ammonolysis of a mixture made up of MeHSiCl₂ and MeViSiCl₂ according to S. Kokott and G. Motz, “Modifizierung des ABSE-Polycarbosilazans mit Multi-Walled Carbon Nanotubes zur Herstellung spinnfähiger Massen” [Modification of the ABSE Polycarbosilazane with Multi-Walled Carbon Nanotubes for the Production of Spinnable Masses], Mat.-wiss. u. Werkstofftech. 2007, 38 (11), 894-900.

N-alkyl-substituted silazanes, in turn, can be easily produced by the specialist in the same way by bringing together the respective halogen silanes with alkyl amines so they can undergo reactions, as described in U.S. Pat. No. 4,935,481 and U.S. Pat. No. 4,595,775.

The selection of the multifunctional cyanates as starting material to be used for the resin is not critical. In principle, every one of the at least bifunctional cyanate bodies can be used, among them especially the aromatic cyanates and, among them, in turn, especially the di- or polyfunctional cyanates having the IV-VII structures shown here:

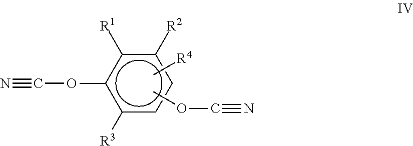

wherein R¹ to R⁴ is, independently from one another, hydrogen, C₁-C₁₀ alkyl, C₃-C₈ cycloalkyl, C₁-C₁₀ alkoxy, halogen (F, Cl, Br or I), phenyl or phenoxy, in which case the alkyl or aryl group can be fluorinated or partially fluorinated. Examples are phenylene-1,3-dicyanate, phenylene-1,4-dicyanate, 2,4,5-trifluorophenylene-1,3-dicyanate;

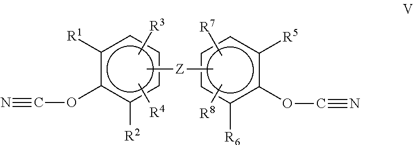

wherein R⁵ to R⁸ is like R¹ to R⁴ and Z is a chemical bond, SO₂, CF₂, CH₂, CHF, CH(CH₃), isopropylene, hexafluoroisopropylene, C₁-C₁₀ alkylene, O, NR⁹, N=N, CH=CH, COO, CH=N, CH=N—N=CH, alkyleneoxyalkylene with C₁-C₈ alkylene, S, Si(CH₃)₂ or

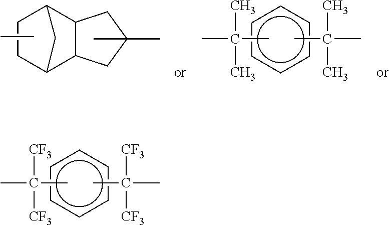

examples are 2,2-bis(4-cyanato-phenyl)propane, 2,2-bis(4-cyanato-phenyl)hexafluoropropane, biphenylene-4,4′-dicyanate;

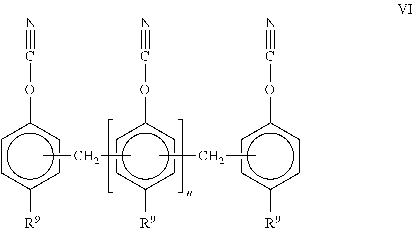

wherein R⁹ is hydrogen or C₁-C₁₀ alkyl and n means an integer between 0 and 20, as well as di- or polyfunctional aliphatic cyanates with at least one fluorine atom in the aliphatic residue and preferably having the VII structure:

N≡C—O—R¹⁰—O—C≡N VII

wherein R¹⁰ is a divalent organic non-aromatic hydrocarbon with at least one fluorine atom and especially with 3 to 12 carbon atoms whose hydrogen atoms can be fully or partially substituted with additional fluorine atoms.

The cyanates mentioned above can be used as monomers or as (still further cross-linkable) prepolymers of the mentioned compounds, either alone or in mixtures thereof or mixed with additional (e.g. monofunctional) cyanates.

Specific examples for usable di- or oligocyanates are the following: The dicyanate of bisphenol A (4,4′-dimethyl methylene diphenyl dicyanate; B10), 4,4′-methyl methylene diphenyl dicyanate (L10), 4,4′methylidene diphenyl dicyanate (M10), compounds with the formula VI, wherein n is 1, 2, 3, 4, 5 or 6, R⁹ is hydrogen and the methylene group is in each case in ortho position with regard to the cyanate group (PT15/PT30).

Examples of additional components are epoxides such as bis-epoxides.

In principle, the proportion of used silazane to used di- or oligocyanate is not critical. However, we recommend to control the mole ratio of the cyanate groups in the di- or polycyanates to the Si—N groups in the silazanes in such a way that the molar quantity of the cyanate groups is used excessively, preferably even twice the quantity, relative to the molar quantity of the Si—N groups in the silazane(s). There are also specific silazane and cyanate combinations that react extremely quickly with one another as undiluted substances and therefore may not be possible to control. If the presence of solvents is not desired for converting such combinations, the weight quantity of silazane should preferably not exceed that of cyanate; for some combinations, a cyanate to silazane weight ratio of at least 3:2, preferably of 4:1 or even of 7:1 to 10:1, is recommended, especially 8:1 to 10:1. Translated into molar ratios, a proportion of cyanate groups to Si—N groups of at least approx. 70:30 (i.e. at least 2:1 or above, for example) is recommended. By adding small quantities of the respective components, the specialist can easily determine what ratios should possibly be avoided in this case. Alternatives for producing a controlled reaction are the conversion in strong dilution through the addition of starting materials with fewer active groups per weight unit (i.e. from oligomeric or relatively low polymeric cyanates and/or silazanes).

If the problem described above does not exist, for a series of applications we recommend mixing the used starting materials for the pre-polymerization process in the absence of solvent (most of the silazanes and some di- and oligocyanates are liquid at room temperature or can be fused at mild temperatures); instead, the reaction can also take place, however, in a suitable solvent such methyl ethyl ketone. In many cases, the initial reaction takes place spontaneously; if need be, one should facilitate it by slightly heating up to about 60-100° C., for example. By request, the reaction can be done under oxygen exclusion, but this method is generally not obligatory. A deaereation or degassing of the charges is often a good idea to extract the gases (ammonia) that could possibly form. Most of the time, within a few minutes to a few hours, a prepolymer is formed that can be cross-linked to a duromer at temperatures of about 100° C. to 250° C. This post-curing releases less heat than the post-curing of pure cyan(ur)ate resins, which facilitates the control of the reaction (see FIGS. 1 & 2 with examples 3a, 3b, 35 and 53 as well as the comparative example); depending on the temperature raised for achieving the effect, it generally lasts few minutes to several hours; as a rule of thumb, it can be said that faster pre-cross-linked starting materials can also be faster post-cross-linked and/or at lower temperatures. Since, as mentioned above, starting mixtures with ratios in ranging from 7:3 to 10:1 (cyanate to silazane) react less vigorously than those having a larger proportion of silazane, most of the time if one follows this rule of thumb they are post-cured at somewhat higher temperatures than mixtures with more silazane. The polymers obtained have duromer properties.

The ratios also help one to control the surface properties of the moldings or solids that have been fully polymerized: Thus, in some cases, a greater proportion of silazane in the mixture to be polymerized can be used for obtaining sticky surfaces, while the polymer made from the same starting components but with a smaller proportion of silazane can result in dry surfaces.

A relatively lower proportion of silazane in the mixture to be polymerized is generally also favorable for obtaining polymers with a relatively high glass transition temperature with relatively high fracture toughness. In this case, changes to the mixture ratio from 7:3 to 8:2, for example, can already lead to a serious rise of T_{g}. Another approach for attaining relatively high glass transition temperatures can be taken by using aromatically substituted silazanes.

Needless to say, the starting components for the polymers according to the invention can be subject to polymerization together with fillers, as known from the production of other cyanate polymers. Examples of fillers can be those mentioned in EP 1854827 A1.

The polymers according to the invention are suitable for the production of prepregs, among other things. For this, the corresponding pre-polymers dissolved in solvents can be used as pre-cross-linked impregnated resins that can be post-cross-linked to duromers under pressure/higher temperature conditions. The impregnated resins, for their part, can be produced through disintegration of the mass-produced pre-polymers or conversion of starting materials in a solvent that is preferably already the solvent of the impregnated resin. The polymers according to the invention can also be produced in form of moldings, which is particularly successful with solvent-free mixtures of the starting materials.

The invention will now be explained in more detail with the examples given below.

Fracture toughness was determined with OCT (optical crack tracing) with a take-up speed of 1 mm/min and a 10 Hz measuring point rate. Sample geometry: CT-body W=35 mm, thickness 6 mm.

Dynamic mechanical analysis (DMA): DMA measurements were carried out at a frequency of 1 Hz with a heat rate of 1 K/min.

The 3-point bending test was carried out following the guidelines of DIN EN ISO 14125.

Fire tests were carried out with a cone calorimeter with a heat flow of 50 kW/m².

The “equivalence ratio” expression used in the examples for indicating the respective proportion of dicyanate to silazane refers to the molar ratio of cyanate to NH groups. Therefore, for these materials an equivalence ratio of 1:1 means that dicyanate and silazane are used in such quantities that they have the same number of NCO and NH groups.

### EXAMPLE 1

### Production of a Polymer from 4,4′-methyl methylene diphenyl dicyanate (L10) and hexamethylcyclotrisilazane (HMCTS)

4,4′-methyl methylene diphenyl dicyanate (L10) was mixed at room temperature (at which it is liquid) with hexamethylcyclotrisilazane (HMCTS) without using solvents in an equivalence ratio of about 7:3.

The mixture was cast in plate-shaped moulds and heated up to 70° C. After approx. 2 hours, the temperature was raised to 200° C. and after an additional 2 hours once again to 250° C. and left at this temperature for 1 hour in order to post-cure the obtained pre-polymer. After 6.5 hours, the temperature was slowly reduced to room temperature. Translucent, slightly yellowish brown plates with dry surfaces were obtained.

### EXAMPLE 2

### Production of a Polymer from 4,4′-methyl methylene diphenyl dicyanate (L10) and trimethyl trivinyl cyclotrisilazane (TMTVCTS).

The dicyanate was mixed with the silazane at room temperature (at which it is liquid) in equivalence ratios between about 7:3 and about 9:1.

It was heated up to 70° C. at an equivalence ratio of 7:3 and left for approx. 2 hours at that temperature. Afterwards, the temperature was raised to 200° C. and left at this temperature for 1 hour. After 6.5 hours, the temperature was slowly lowered to room temperature. Translucent, slightly yellowish brown plates were obtained. They had a glass transition temperature of about 80° C.

In another curing variant, the mixtures (equivalence ratios from 7:3 to 9:1) were also cast into plate-shaped moulds and heated up to 70° C. After approx. 2 hours, the temperature was raised to 200° C. and after an additional 2 hours once again raised to 250° C. and left at this temperature for 1 hour in order to post-cure the pre-polymer obtained. After 6.5 hours, the temperature was slowly lowered to room temperature. Translucent, slightly yellowish brown plates with dry surfaces were obtained.

The values for fracture toughness (K_{1c}) and the glass transition temperatures (T_{g}) for samples from the starting materials (a) 7:3, (b) 7.5:2.5, (c) 7.8:2.2, (d) 8:2, (e) 8.5:1.5, (f) 9:1 and (g) 9.5:0.5 as well as for the reference L10 are given in Table 1:

TABLE 1

| Sample | K_{1c} [N/mm^{3/2}] | T_{g}[° C.] |
|---|---|---|
| a | — | 80 |
| b | 1.34 | 124 |
| c | 0.75 | 190 |
| d | 0.80 | 210 |
| e | 0.62 | 223 |
| f | 0.54 | 243 |
| g | 0.52 | 267 |
| Reference (L10) | 0.58 | 299 |

Generally speaking, the glass transition temperature of the polymers obtained rises with the increasing cyanate content.

Table 2 lists the fire test results for the individual equivalence ratios (a) 7:3, (b) 7.5:2.5, (c) 7.8:2.2 (d) 8:2, (e) 8.5:1.5, (f) 9:1, (g) 9.5:0.5 compared to cured PT15 (a commercially available oligo(3-methylene-1,5-phenylcyanate) with a relatively low degree of oligomerization) and 4,4′-methyl methylene diphenyl dicyanate (L10):

TABLE 2

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| a | 126 | 155 | 51 | 64 | 336 | 24 |
| b | 116 | 158 | 48 | 63 | 252 | 25 |
| c | 93 | 153 | 37 | 35 | 708 | 29 |
| d | 106 | 119 | 51 | 78 | 528 | 34 |
| e | 97 | 131 | 39 | 64 | 822 | 39 |
| f | 96 | 128 | 77 | 145 | 860 | 47 |
| g | 107 | 155 | 75 | 117 | 721 | 44 |
| PT15 | 91 | 185 | 45 | 56 | 629 | 44 |
| L10 | 99 | 162 | 65 | 142 | 2507 | 60 |

Abbreviations:
TTI = Time of ignition
HRRpeak = Heat release rate peak
MARHE (maximum average rate of heat emission
THR = Total heat release
TSR = Total smoke released

The moisture absorption of two sticks made of L10 and TMTVCTS at a ratio of 8:2 and 7:3 was tested through storage in water. The average moisture absorption for the stick from the starting materials having a 8:2 ratio was about 0.85%, for the one made of the materials having a 7:3 ratio it was below 0.7%. After 28 days, it was in both cases barely above 1, meaning it barely rose.

### EXAMPLES 3a & 3b

4,4′-methyl methylene diphenyl dicyanate (L10) was mixed at room temperature (at which it is liquid) with vinyl-methyl-polysilazane (VL100) (example 3a) or with a cyclic silazane, obtained from 50 mol % dichlorovinylmethylsilane and 50 mol % dichloro-dimethylsilane (VML50) (example 3b) without solvents in an equivalence ratio of 8:2. Each mixture was placed in a mold and cured at a maximum curing temperature of 200° C. according to variant 1 (equivalence ratio 1:1) of example 2. The glass transition temperature T_{g} for the fully cured polymer from example 3b was determined with 185° C.; that of example 3a was slightly above.

FIG. 1 shows the exothermic processes of the reactions in accordance with example 3a (curve A) and 3b (curve 3b). The integrals for −ΔH (J/g−¹) have a value of 450 and 480.

### EXAMPLE 4

Example 3 was repeated, but in this case VML50 substituted by a polyphenyl methyl silazane (PML100). Comparable results were obtained. The glass transition temperature T_{g} for the fully cured polymer was determined with 204° C.

### EXAMPLE 5

Example 4 was repeated, but in this case the equivalence ratio of cyanate to silazane was 7:3.

### EXAMPLE 6

Example 3 was repeated, but in this case VML50 was substituted by a cyclic silazane made from 50 mole % vinylmethylsilyl amino groups and 50 mole % phenylmethylsilyl amino groups (PVL50). The glass transition temperature T_{g} for the fully cured polymer was determined with 190° C.

A combustibility test analogous to UL94 was carried out for examples 3 through 6. Burning drip-off could not be observed in any one of the samples. A full burning-off of the sample was not observed in any one of the samples either; the samples did not become sooty.

Table 3 shows the fire test results according to Ul194 for examples 3 through 6:

TABLE 3

| | Post-combustion | Post-combustion | |
|---|---|---|---|
| | after 1^{st} flame | after 2^{nd} flame | |
| | impingement of | impingement of | Classification |
| Example | 10 s | 10 s | according to UL94 |
| 3 | <1 s | <1 s | V0 |
| 4 | <1 s | 7 s | V0 |
| 5 | <1 s | <1 s | V0 |
| 6 | 1 s | 4 s | V0 |

### EXAMPLE 7

Example 3 was repeated, but in this case 4,4′-methyl methylene diphenyl dicyanate (L10) was substituted by 4,4′-dimethyl methylene diphenyl dicyanate (B10). The glass transition temperature was determined with 215° C.

### EXAMPLE 8

Example 7 was repeated, but in this case VML50 was substituted by a cyclic silazane made up of 85 mole % dimethylsilyl amino groups and 15 mole % methylsilyl amino groups (ML85). The glass transition temperature was determined with 217° C.

### EXAMPLE 9

Example 7 was repeated, but in this case VML50 was substituted by a cyclic silazane made up of 100 mole % dimethylsilyl amino groups (ML100). The glass transition temperature was determined with 215° C.

A combustibility test according to UL94 was carried out for examples 7 to 9. Burning drip-off could not be observed in any one of the samples. A full burning-off of the sample was not observed in any one of the samples either; the samples did not become sooty. The results of the fire tests determined according to Ul94 for examples 7 to 9 are shown in Table 4:

TABLE 4

| | Post-combustion | Post-combustion after | Classification |
|---|---|---|---|
| Exam- | after 1^{st} flame | 2^{nd} flame impingement | according to |
| ple | impingement of 10 s | of 10 s | UL94 |
| 7 | 5 s | 25 s | V1 |
| 8 | 3 s | 20 s | V1 |
| 9 | <1 s | 19 s | V1 |

### EXAMPLE 10

Example 9 was repeated, but in this case 4,4′-dimethyl methylene diphenyl dicyanate (B10) was substituted by 4,4′methylidene diphenyl dicyanate (M10). The glass transition temperature was determined with 239° C.

### EXAMPLE 11

Example 4 was repeated, but in this case 4,4′-methyl methylene diphenyl dicyanate (L10) was substituted by 4,4′methylidene diphenyl dicyanate (M10). The glass transition temperature was determined with 224° C.

### EXAMPLE 12

Example 6 was repeated, but in this case 4,4′-methyl methylene diphenyl dicyanate (L10) was substituted by 4,4′methylidene diphenyl dicyanate (M10).

### EXAMPLE 13

Example 3 was repeated, but in this case 4,4′-methyl methylene diphenyl dicyanate (L10) was substituted by 4,4′methylidene diphenyl dicyanate (M10). The glass transition temperature was determined with 238° C.

### EXAMPLE 14

Example 5 was repeated, but in this case 4,4′-methyl methylene diphenyl dicyanate (L10) was substituted by 4,4′methylidene diphenyl dicyanate (M10). The glass transition temperature was determined with 235° C.

A combustibility test according to UL94 was carried out for examples 10 to 14. Burning drip-off could not be observed in any one of the samples. A full burning-off of the sample was not observed in any one of the samples either; the samples did not become sooty. The results of the fire tests determined according to Ul94 for examples 10 to 14 are shown in Table 5:

TABLE 5

| | Post-combustion after | Post-combustion after | Classification |
|---|---|---|---|
| Exam- | 1^{st} flame impingement | 2^{nd} flame impingement | according to |
| ple | of 10 s | of 10 s | UL94 |
| 10 | <1 s | 16 s | V1 |
| 11 | 2 s | 9 s | V0-V1 |
| 12 | 1 s | 1 s | V0 |
| 13 | <1 s | 28 s | V1 |
| 14 | <1 s | 10 s | V0-V1 |

### EXAMPLE 15

4,4′-methyl methylene diphenyl dicyanate (L10) was mixed at room temperature (at which it is liquid) without solvents in an equivalence ratio of 8:2 with a cyclic silazane, prepared from 85 mole % dichlorodimethylsilane and 15 mole % of dichloromethyl-silane (ML85). The mixtures were afterwards cast into plate-shaped molds, heated up to 70° C. and then cured at 200° C. Translucent, slightly yellowish-brown plates were obtained.

### EXAMPLE 16

Example 15 was repeated, but in this case ML85 was substituted by a cyclic silazane, prepared from 100 mole % dichlorodimethylsilane (ML100).

### EXAMPLE 17

Example 15 was repeated, but in this case ML85 was substituted by a cyclic silazane, prepared from a 50 mole % dichlorovinylmethylsilane and a 50 mole % dichloro-dimethylsilane (VM L50). Comparable results were obtained.

### EXAMPLE 18

Example 15 was repeated, but in this case ML85 was substituted by a cyclic silazane, prepared from 50 mole % dichloromethylvinylsilane and 50 mole % dichloromethyl-phenylsilane (PVL50).

### EXAMPLE 19

Example 15 was repeated, but in this case ML85 was substituted by a cyclic silazane made up of 100 mole % phenylmethylsilyl amino groups (PML100). The K_{1c} values and the glass transition temperatures for examples 16, 17 and 18 are listed in Table 6.

TABLE 6

| | K_{1c} | T_{g} |
|---|---|---|
| Example | [MN/m^{3/2}] | [° C.] |
| 16 | 0.88 | 202 |
| 17 | 0.66 | 202 |
| 18 | 0.90 | 180 |

The fire test values for examples 15 through 19 in relation to PT15 and L10 (4,4′-methyl methylene diphenyl dicyanate) are listed in Table 7.

TABLE 7

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 15 | 81 | 138 | 55 | 87 | 2054 | 51 |
| 16 | 101 | 150 | 67 | 119 | 2618 | 64 |
| 17 | 97 | 116 | 52 | 51 | 1686 | 42 |
| 18 | 112 | 138 | 54 | 90 | 1381 | 44 |
| 19 | 94 | 151 | 47 | 114 | 1015 | 48 |
| PT15 | 91 | 185 | 45 | 56 | 629 | 44 |
| L10 | 99 | 162 | 65 | 142 | 2507 | 60 |

### EXAMPLE 20

Example 15 was repeated, but in this case 4,4′-methyl methylene diphenyl dicyanate (L10) was substituted by 4′methylidene diphenyl dicyanate (M10).

### EXAMPLE 21

Example 16 was repeated, but in this case 4,4′-methyl methylene diphenyl dicyanate (L10) was substituted by 4,4′methylidene diphenyl dicyanate (M10).

### EXAMPLE 22

Example 17 was repeated, but in this case 4,4′-methyl methylene diphenyl dicyanate (L10) was substituted by 4,4′methylidene diphenyl dicyanate (M10).

### EXAMPLE 23

Example 18 was repeated, but in this case 4,4′-methyl methylene diphenyl dicyanate (L10) was substituted by 4,4′methylidene diphenyl dicyanate (M10).

### EXAMPLE 24

Example 19 was repeated, but in this case 4,4′-methyl methylene diphenyl dicyanate (L10) was substituted by 4,4′methylidene diphenyl dicyanate (M10).

Table 8 lists the K_{1c} values and glass transition temperatures for examples 20 to 24.

TABLE 8

| Examples | K_{1c} [MN/m^{3/2}] | T_{g} [° C.] |
|---|---|---|
| 20 | 0.53 | 244 |
| 21 | 0.58 | 239 |
| 22 | 0.80 | 214 |
| 23 | 0.63 | 222 |
| 24 | — | 194 |

The fire test values for examples 20 to 24 related to reference samples PT15 and 4,4′methylidene diphenyl dicyanate (M10) are listed in Table 9.

TABLE 9

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 20 | 69 | 180 | 69 | 128 | 1302 | 54 |
| 21 | 72 | 205 | 96 | 147 | 2919 | 53 |
| 22 | 98 | 173 | 55 | 93 | 898 | 48 |
| 23 | 74 | 169 | 58 | 84 | 1007 | 40 |
| 24 | 72 | 155 | 53 | 78 | 837 | 41 |
| PT15 | 91 | 185 | 45 | 56 | 629 | 44 |
| M10 | 57 | 286 | 149 | 111 | 3439 | 76 |

### EXAMPLE 25

Example 21 was repeated several times, but in this case the equivalence ratio of cyanate to silazane (ML100) was 8:2, 8.5:1.5 and 9:1.

Table 10 lists the K-_{1c} values and the glass transition temperatures for example 25.

TABLE 10

| | K_{1c} | T_{g} |
|---|---|---|
| Examples | [MN/m^{3/2}] | [° C.] |
| 8:2 | 0.64 | 231 |
| 8.5:1.5 | 0.50 | 254 |
| 9:1 | 0.41 | 240 |

The fire test values for example 25 in relation to reference samples PT15 and 4,4′methylidene diphenyl dicyanate (M10) are listed in Table 11.

TABLE 11

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 8:2 | 89 | 169 | 80 | 110 | 2301 | 55 |
| 8.5:1.5 | 66 | 182 | 60 | 90 | 2463 | 58 |
| 9:1 | 65 | 206 | 66 | 106 | 1572 | 58 |
| PT15 | 91 | 185 | 45 | 56 | 629 | 44 |
| M10 | 57 | 286 | 149 | 111 | 3439 | 76 |

### EXAMPLE 26

A methylated silazane made up of phenyl methylsilyl methylamino groups (PML100N) was mixed with L10 in an equivalence ratio of 8:2 at room temperature, with B10 at approx. 75° C., and with M10 at over 100° C.

### EXAMPLE 27

A methylated silazane made up of dimethylsilyl methylamino groups (ML100N) was mixed with B10 at approx. 75° C. in the equivalence ratio of 8:2.

### Example 28

A sample was produced from 4,4′-dimethyl methylene diphenyl dicyanate (B10) and ML100N by mixing cyanate and silazane at 75° C. in an equivalence ratio of 8:2 and the mixture was given to an open mold. The curing took place at a maximum curing temperature of 200° C.

### EXAMPLE 29

Example 28 was repeated, but in this case 4,4′-methyl methylene diphenyl dicyanate (B10) was substituted with 4,4′methylidene diphenyl dicyanate (M10) and ML100N by PL100N. The mixing was done at 100° C.

### EXAMPLE 30

4,4′-dimethyl methylene diphenyl dicyanate pre-polymer (B10 pre-polymer, 35% conversion) was mixed in an equivalence ratio of 8:2 at approx. 50° C. with a cyclic silazane made up of 50 mole % of vinylmethylsilylamino and 50 mole % of dimethyl-amino groups (VML50).

### EXAMPLE 31

Example 30 was repeated, but in this case VML50 was substituted by a cyclic silazane made up of 50 mole % of vinylmethylsilylamino and 50 mole % of phenylsilylamino groups (PVL50).

### EXAMPLE 32

Example 30 was repeated, but in this case VML50 was substituted by a cyclic silazane made up of 100 mole % phenylmethylsilylamino groups (PML100).

### EXAMPLE 33

A sample was produced from a 4,4′dimethyl methylene diphenyl dicyanate (B10) pre-polymer (35% conversion) and VML50. In this case, the mixture was mixed in an equivalence ratio of 8:2 at approx. 50° C. and given to an open mold. The curing took place in two steps, 2 hours at about 130° C. and approx. 1.5 hours at 200° C. The glass transition temperature was determined with 224° C.

### EXAMPLE 34

Example 33 was repeated, but in this case VML50 was replaced by PML100. The glass transition temperature was determined with 233° C.

### EXAMPLE 35

Mixtures from L10 and PT 15 having the weight ratios of 1:1 and 1:4 were prepared and in each case mixed with VML50, PVL50 and PML100 in the equivalence ratio of 8:2. Miscibility is given at about 50° C. FIG. 1 shows the reaction's exothermic process with VML50; the integral −ΔH (J/g−¹) is 432.

### EXAMPLE 36

A mixture of L10 and PT30 in the weight ratio of 1:1 was produced and in each case mixed with VML50, PVL50 and PML100 in the equivalence ratio of 8:2. Miscibility is given at about 60° C.

### EXAMPLE 37

A sample was produced from the L10/PT15 cyanate mixture (weight ratio 1:4) and VML50. The cyanate-silazane mixture was mixed at the equivalence ratio of 8:2 at approx. 50° C. and given to an open mold. Curing took place at a maximum curing temperature of 200° C. The glass transition temperature was determined with 223° C.

### EXAMPLE 38

A sample was produced from the L10/PT15 cyanate mixture (weight ratio 1:1) and PML100. The cyanate-silazane mixture was mixed at the equivalence ratio of 8:2 at approx. 60° C. and given to an open mold. Curing took place at a maximum curing temperature of 200° C. The glass transition temperature was determined with 212° C.

### EXAMPLE 39

A two-layered glass laminate was produced by impregnating glass tissue with the mixture of a B10 pre-polymer and ABSE (equivalence ratio of 7:3) in toluene. Two of the prepreg layers formed in this way, which had been stored for 5 days at room temperature, were molded for 15 minutes at 200° C. The resin flow was determined with 9%.

### EXAMPLE 40

Example 39 was repeated, but in this case the prepregs were pre-dried for 2 minutes at 50° C. and stored for 1 hour at room temperature. Toluene was substituted here with methyl ethyl ketone (MEK).

The resin flow was determined with 17%.

### EXAMPLE 41

A six-layered glass laminate was produced by impregnating glass tissue with a mixture of L10 and VML50 (equivalence ratio of 8:2) in methyl ethyl ketone (MEK). The prepregs were pre-dried for 15 minutes at 150° C. and molded for 2 hours at 200° C. (pre-heated press)

### EXAMPLE 42

Example 41 was repeated, but in this case the prepregs were first molded for 1 hour at 70° C., for 1 hour at 130° C. and finally for 1 hour at 200° C.

### EXAMPLE 43

Example 42 was repeated, but in this case the prepregs were pre-dried for 20 minutes at 150° C.

### EXAMPLE 44

A six-layered glass laminate was produced by impregnating glass tissue with a mixture of L10 and VML50 (equivalence ratio of 8:2) in MEK. The prepregs were pre-dried at 20 minutes at 150° C. and molded for 2 hours at 200° C. The resin content of the prepreg solution was 30-35% by weight.

### EXAMPLE 45

A hand laminate with alternating structure (glass tissue-glass fiber mat-glass tissue) was produced by impregnating seven glass layers with the mixture of L10 and PML100 (equivalence ratio of 8:2) and the layers interlinked with the help of various venting rolls. The laminate was then stored for several hours keeping it under several different temperature stages (maximum temperature: 150° C.). The glass transition temperature was determined with 166° C. Table 12 lists the fire test results.

TABLE 12

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 45 | 65 | 198 | 102 | 34 | 1300 | 29 |

### EXAMPLE 46

A hand laminate with alternating structure (glass tissue-glass fiber mat-glass tissue) was produced by impregnating seven glass layers with the mixture of L10 and VML50 (equivalence ratio of 8:2) and the layers interlinked with the help of various venting rolls Curing took place at the maximum curing temperature of 200° C.

Table 13 lists the burning values for example 46.

TABLE 13

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 46 | 65 | 135 | 68 | 43 | 1466 | 25 |

### EXAMPLE 47

Example 46 was repeated, but in this case a six-layer hand laminate was produced and the glass material used was glass tissue. Table 14 lists the fire test values for example 47.

TABLE 14

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 47 | 69 | 168 | 83 | 21 | 863 | 18 |

### EXAMPLE 48

A six-layer RTM (resin transfer molding) structural part was produced by mixing L10 and VML50 at room temperature in the equivalence ratio of 8:2. A six-layered glass tissue structure was impregnated by means of pressure RTM and the structural part obtained cured at 200° C. The glass transition temperature was determined with approx. 214° C.

Table 15 shows the fire test results.

TABLE 15

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 48 | 32 | 99 | 31 | 6 | 117 | 25 |

### EXAMPLE 49

Example 48 was repeated, but instead of the six-layered glass tissue structure, a four-layered glass tissue structure was used with the vacuum RTM. Table 16 lists the fire test results.

TABLE 16

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 49 | 29 | 215 | 66 | 5 | 190 | 19 |

### EXAMPLE 50

Example 48 was repeated, but instead of the six-layered glass tissue structure, a nine-layered glass tissue structure was used with the vacuum RTM. The glass transition temperature was determined with approx. 215° C. Table 17 lists the fire test results.

TABLE 17

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 50 | 75 | 211 | 77 | 25 | 667 | 20 |

A bending test (the 3-point bending test) was carried out with both materials and the two averages determined. For the L10 glass fiber, the value was 350 Mpa, for the L10/VML50 glass fiber, it was 393 Mpa.

### EXAMPLE 51

Example 50 was repeated, but in this case a carbon fiber tissue structure was used instead. The glass transition temperature was determined with approx. 205° C. The fires test results are listed in Table 18.

TABLE 18

| | TTI | HRRpeak | MARHE | THR | TSR | Δm |
|---|---|---|---|---|---|---|
| Example | [s] | [kW/m²] | [kW/m²] | [MJ/m²] | [m²/m²] | [%] |
| 51 | 80 | 168 | 72 | 20.8 | 716 | 21 |

A bending test (the 3-point bending test) was carried out with the material and the average determined for the L10/VML50 carbon fiber, namely 803 Mpa.

### EXAMPLE 52

Two glass plates were glued together. To do this, a mixture from L10 and VML50 was produced in the equivalence ratio of 8:2 and applied as thin layer between two glass plates. Hardening took place at a maximum hardening temperature of 200° C. A transparent, flat bonding was obtained.

### EXAMPLE 53

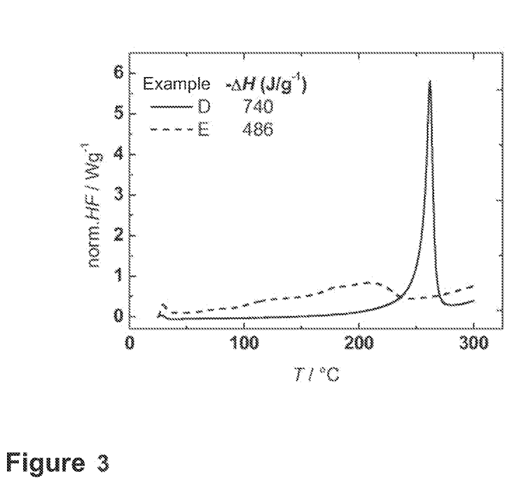

Triglycidyl-para-aminophenol (TGPAP) and PT15 with the equivalence ratio of 1:1 were mixed with 10% by weight of a previously cross-linked silazane made from 33 mole % dimethylsilylamino and 67 mole % methylsilylamino groups (ML33 S). The post-curing at relatively mild temperatures showed an exothermic value of −ΔH (J/g−¹)=486, see FIG. 3.

### COMPARATIVE EXAMPLES

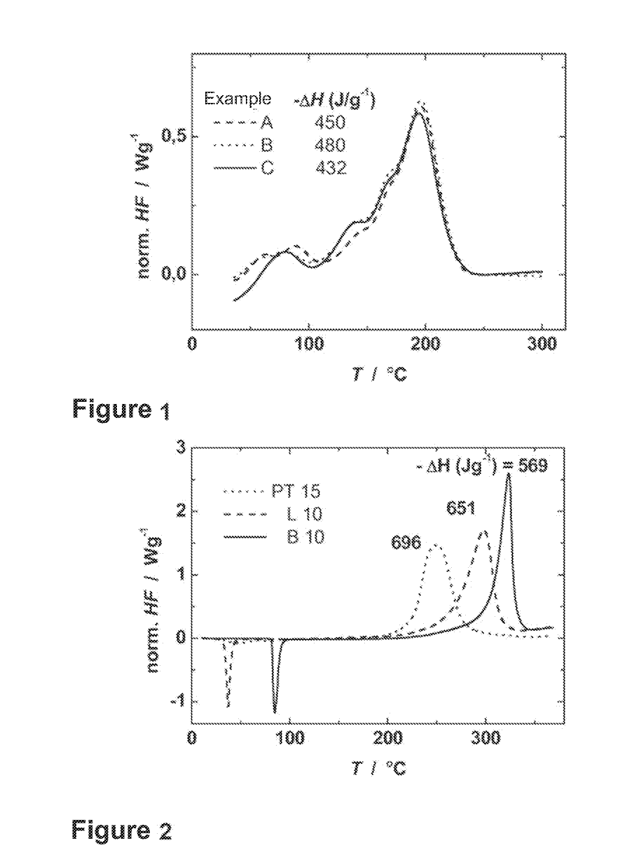

FIG. 2 shows the exothermic reaction of the curing of pure cyanates, namely of PT15 (−ΔH (J/g−¹)=696), of L10 (−ΔH (J/g−¹)=651) and of B10 (−ΔH (J/g−¹)=569). The curing reaction takes place only when considerably higher temperatures are reached compared to those of the previous examples. FIG. 3 indicates the exothermia of the curing of a TGPAP and PT15 mixture having the equivalence ratio of 1:1. The value of −ΔH (J/g−¹)=740 was significantly higher than the one obtained for example 53.

1. Hybrid pre-polymer, obtainable through conversion of at least
(i) one or several difunctional, oligofunctional and/or polyfunctional cyanate(s) and/or from one or several pre-polymeres there from, and
(ii) one or several monomeric, oligomeric and/or polymeric silazane(s).

2. Hybrid pre-polymer according to claim 1, wherein the molar ratio of the cyanate groups present in the cyanate(s) in accordance with (i) is equal to or higher than 70:30 compared to the Si—N groups present in the silazane(s) in accordance with (ii), preferably equal or higher than 75:35 and especially preferable if equal to or higher than 80:20.

3. Hybrid pre-polymer according to claim 1, obtainable through conversion of at least
(i) one or several difunctional, oligofunctional and/or polyfunctional cyanate(s) and/or from one or several pre-polymeres there from, and
(ii) one or several monomeric, oligomeric and/or polymeric silazane(s), selected from among those having the general formula (I): 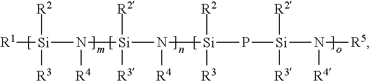
the general formula (II): 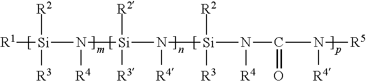
and the general formula (III): 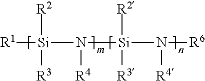
wherein
(a) R² and R³ are equal or different and mean hydrogen or a straight-chain, branched or cyclic, substituted or non-substituted alkyl, alkenyl, aryl, arylalkyl, alkylaryl, alkenylaryl or arylalkenyl, in which case every one of the R² and R³ substituents has a different or the same meaning in different units if m and/or o are larger than 1,
R²′ and R³′ are the same or different and mean straight-chain, branched or cyclic, substituted or non-substituted alkyl, alkenyl, aryl, arylalkyl, alkylaryl, alkenylaryl or arylalkenyl, in which case every one of the R²′ and R³′ substituents has a different meaning or the same meaning in different units if n and/or o are larger than 1,
or
(b) as far as at least one residue R³ and one residue R³′ are available, R² and R²′ have the meaning indicated above and (i) all or (ii) in each case a part of the residues R³ and R³′ together represent a non-substituted or substituted, straight-chain or branched alkylene group, in which case in variant (ii) the remaining part of residues R³ and R³′ has the meaning indicated under (a),
and wherein
R⁴ and R⁴′ mean alkyl, phenyl or hydrogen, in which case several residues R⁴ and/or R⁴′ can be equal to or different in one molecule of compounds (I) to (III) in each case,
R¹ and R⁵ are the same or different and can have the same meaning as R² or R³, in which case R⁵ can also mean Si(R¹)(R²′)(R³′) or R¹ and R⁵ together represent a single bond,
R⁶ means Si(R²)(R²′)—X—R⁷—Si(R²)_{q}(OR²′)_{3-q}, wherein X means either O or NR⁴, R⁷ represents a single bond or a substituted or non-substituted, straight-chain, branched or cyclic alkylene group and q can be 0, 1, 2 or 3,
P is an alkylene group with 1 to 12 carbon atoms,
m and p mean independently from one another 1, 2, 3, 4, 5, 6, 7, 8, 9, 10 or an integer between 11 and 25000, and
n and o mean independently from one another 0, 1, 2, 3, 4, 5, 6, 7, 8, 9, 10 or an integer between 11 and 25000,
in which case the units placed in square brackets can be distributed in the respective molecule in a uniform, randomized or block-wise way.

4. Hybrid pre-polymer according to claim 1, obtainable through conversion of at least
(i) one or several cyanate(s), selected from among those having the structures IV-VI shown below: 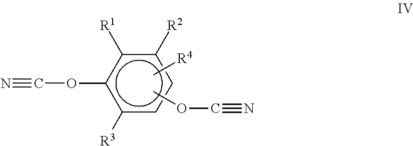
wherein R¹ to R⁴ can be independently from one another hydrogen, C₁-C₁₀ alkyl, C₃-C₈ cycloalkyl, C₁-C₁₀ alkoxy, halogen (F, Cl, Br or I), phenyl or phenoxy, in which case the alkyl or aryl groups can be fluoridated or partially fluoridated, 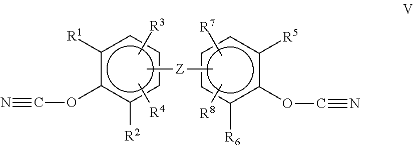
wherein R¹ to R⁸ like R¹ to R⁴ are defined for formula IV and Z is a chemical bond, SO₂, CF₂, CH₂, CHF, CH(CH₃), isopropylene, hexafluoroisopropylene, C₁-C₁₀ alkylene, O, NR⁹, N=N, CH=CH, COO, CH=N, CH=N—N=CH, alkylene-oxyalkylene with C₁-C₈ alkylene, S, Si(CH₃)₂ or 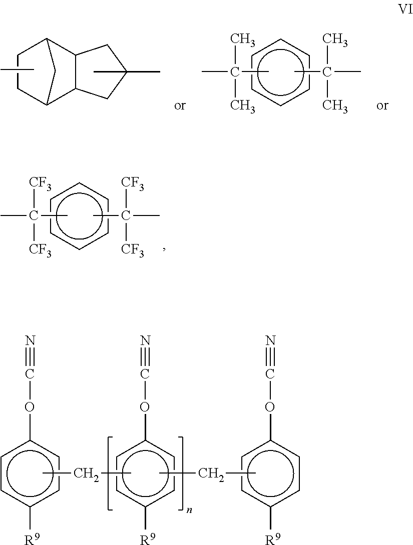
wherein R⁹ is hydrogen or C₁-C₁₀ alkyl and n means an integer from 0 to 20, di- or polyfunctional aliphatic cyanates,
as well as one or several pre-polymers there from,
and
(ii) one or several monomeric, oligomeric and/or polymeric silazane(s) as defined in claim 1.

5. Hybrid pre-polymer according to claim 3, wherein the di- or polyfunctional aliphatic cyanate(s) are selected from among cyanates with at least one fluorine atom in the aliphatic residue and /or the structure VII:
N≡C—O—R¹⁰—O—C≡N VII
wherein R¹⁰ is a divalent organic non-aromatic hydrocarbon with at least one fluorine atom and especially with 3 to 12 carbon atoms, whose hydrogen atoms can be fully or partially substituted by additional fluorine atoms.

6. Hybrid pre-polymer according to claim 1, obtainable by converting the components (i) and (ii) as well as (iii) one or several additional components.

7. Hybrid pre-polymer according to claim 6, characterized in that the one or several component(s) is/are selected from organic monocyanates.

8. Hybrid pre-polymer according to claim 6, characterized in that the one or at least several component(s) is/are selected from fillers.

9. Hybrid pre-polymer according to claim 6, characterized in that the one or at least several component(s) is/are selected from epoxy compounds and their pre-polymers, and especially from di- or polyfunctional epoxy compounds.

10. Hybrid pre-polymer according to claim 6, characterized in that it can be shaped and/or melted.

11. Hybrid pre-polymer according to claim 10, characterized in that it is present as impregnation or coating of a flat textile material.

12. Hybrid pre-polymer according to claim 11, characterized in that the flat textile material is made especially from glass fibers or contains them.

13. Hybrid pre-polymer according to claim 1, characterized in that it is present in dissolved form.

14. Duromer, obtainable by post-cross-linking of a hybrid pre-polymer according to claim 1.

15. Duromer according to claim 14, characterized in that it is present in the form of a one-sided, two-sided or continuous coating of a flat textile material.

16. Duromer according to claim 14, characterized in that it is present in the form of a three-dimensional body.

17. Use of a duromer according to claim 15 as fire-protected structural part.

18. Process for the production of a hybrid pre-polymer as defined in claim 1, characterized in that the cyanate(s) and the silazane(s) are mixed with each other in the liquid state in the absence of a solvent and brought to react.

19. Process for the production of a hybrid pre-polymer as defined in claim 1, characterized in that the cyanate(s) and the silazane(s) are mixed in a solvent and brought to react.

20. Process for the production of a duromer according to claim 12, characterized in that a hybrid pre-polymer is produced and the hybrid pre-polymer is afterwards post-cross-linked by applying pressure and/or heat.
